(19) United States
(12) Patent Application Publication
(10) Pub. No.: US 2023/0367828 A1
(43) Pub. Date: Nov. 16, 2023

(54) SYSTEMS AND METHODS FOR ENHANCING EXPLORATION AND DISCOVERABILITY OF EVENTS AND ACTIVITIES AND CONTENT CREATION COLLABORATION

(71) Applicant: LOCALBUZZ, INC., Phoenix, AZ (US)

(72) Inventor: Adrian GILLETTE, Phoenix, AZ (US)

(73) Assignee: LOCALBUZZ, INC., Phoenix, AZ (US)

(21) Appl. No.: 18/310,011

(22) Filed: May 1, 2023

Related U.S. Application Data
(63) Continuation of application No. PCT/US21/72252, filed on Nov. 4, 2021.
(60) Provisional application No. 63/112,706, filed on Nov. 12, 2020.
(60) Provisional application No. 63/112,903, filed on Nov. 12, 2020.

(51) Int. Cl. G06F 16/9537; G06F 16/9535; G06F 16/735

(52) U.S. Cl. CPC G06F 16/9537; G06F 16/9535; G06F 16/735

(57) ABSTRACT

The disclosed systems and methods facilitate creation and posting of contention related to events and locations and exploration and discoverability of local events which is fast and easy. The disclosed systems also facilitate connections between content creators and businesses desiring content.

### CROSS-REFERENCE

This application is a continuation of PCT/US2021/072252 filed Nov. 4, 2022, which application claims the benefit of U.S. Provisional Application Nos. 63/112,706 and 63/112,903, both filed Nov. 12, 2020, which applications are incorporated herein in their entirety by reference.

### BACKGROUND

The 2019 Digital report from Hootsuite and We Are Social, shows that people spend an average of 6 hours and 42 minutes online each day. Half of that time is spent online from a mobile device. There are many reasons why people are online including, online searching, social networking sites, social media sites, and online review sites to name a few. In conjunction with increasing time online, every day roughly 2.5 quintillion bytes of data is created adding to the amount of information available.

Online search is the process of interactively searching for and retrieving information via an internet connected device (computer, tablet, phone, etc.). Interactive searches became possible in the 1980s with the advent of faster databases and smart computer terminals. Today, searches through web-based search engines constitute the majority of online searches. Google®, one of the most popular search engines, processes over 3.5 billion searches a day. With 2.5 quintillion bytes of data created each day, searching and finding relevant data quickly becomes increasingly complex and difficult.

Facebook®, the world's largest social networking platform, has over 2 billion users. Other social networking media platforms, including Youtube® and Whatsapp®, also have more than one billion users each. Even the relative social media newcomer TikTok® has almost 1 billion users. The current world population is estimated at 7.7 billion people, with at least 3.5 billion online. This means social media platforms are used by one-in-three people in the world, and more than two-thirds of all internet users.

The internet provides great tools for finding information (search engines like Google), finding a location (Google maps), getting information or recommendations about a place or service (services such as TripAdvisor®, Yelp® and Foursquare®), and upcoming events (Facebook Local, Eventbrite®, etc.).

None of the currently available tools provide a way to deliver a good match between an event or location and an individual user's interests or a way for content creators to create and post content about an event or location. Additionally, available tools do no provide a quick and efficient mechanism to explore and discover what is happening nearby or at a target location, or quick access to large volume of visual content that is both timely and relevant. This problem gets worse with the 2.5 quintillion bytes of data that is created daily.

What is needed are computer implemented tools that provide a way to create and post content about events and locations and to deliver relevant matches between an event or location and an individual user's interests. Additionally, what is needed are computer implemented tools that provide a quick and efficient mechanism to explore and discover what is happening or quick access large volumes of visual content that is both timely and relevant. Additionally, a need exists to match content creators with local businesses to provide a mechanism for small businesses to have content created that reaches potential local customers.

### SUMMARY

Disclosed are computer implemented tools that provide a way to create and post content about events and locations and to deliver relevant matches between an event or location and an individual user's interests. Additionally, what is disclosed are computer implemented tools that provide a quick and efficient mechanism to explore and discover what is happening or quick access large volumes of visual content that is both timely, relevant and highly usable. Also disclosed are computer implemented tools that provide a mechanism to connect businesses with local content creators.

The disclosed systems and methods facilitate creation and posting of content related to events and locations and exploration and discoverability of local events which is fast and easy. In the discovery process a user interface is provided that allows the user to make quick changes along two dimensions (e.g., geo-location and category) to generate a custom feed that is relevant and timely to that user. Using geo-location information, the system is configurable to dynamically query a database of content within a target geographic boundary. A default geographic location can be used that is based on a device location, e.g. ascertained from global positioning system (“GPS”) information. Users can also engage an intuitive workflow to change location, e.g., to an intended location. Content is organizable into categories, in which the category labels are presented in the user interface. For each category content can be ordered chronologically from recent to oldest. Users can switch between categories to view content feeds of the category. The systems and methods provide fast and easy exploration and discovery tools for events. Large volumes of visual content can also be provided that is timely and relevant. The systems and methods allow users to stay up-to-date with local events.

### INCORPORATION BY REFERENCE

All publications, patents, and patent applications mentioned in this specification are herein incorporated by reference to the same extent as if each individual publication, patent, or patent application was specifically and individually indicated to be incorporated by reference.
U.S. Pat. No. 9,158,851 B2 by Chand et al. dated Oct. 13, 2015;
U.S. Pat. No. 9,843,642 B2 by Sole dated Dec. 12, 2017;
U.S. Pat. No. 9,848,297 B2 by Garcia et al. dated Dec. 19, 2017;
U.S. Pat. No. 9,866,999 B1 by Noeth et al. dated Jan. 9, 2018;
U.S. Pat. No. 9,946,984 B2 by Ahari et al. dated Apr. 17, 2018;
U.S. Pat. No. 10,117,044 B2 by Sharon et al. dated Oct. 30, 2018;
U.S. Pat. No. 10,250,703 B2 by Wilden et al. dated Apr. 2, 2019;
U.S. Pat. No. 10,467,282 B2 by Shorman et al. dated Nov. 5, 2019;
U.S. Pat. No. 10,659,914 B1 by Allen et al. dated May 19, 2020;
U.S. Pat. No. 10,798,094 B2 to Wei issued Oct. 6, 2020, for Blockchain-based account management;
US 2010/0305855 A1 by Dutton et al. Dec. 2, 2010;
US 2019/0259107 A1 by Hollis et al. dated Aug. 22, 2019;
US 2020/0175086 A1 by Pavlovskaia et al. dated Jun. 4, 2020;
L I, et al. Analysis of a Location-based Social Network, https://core.ac.uk/download/pdf/209002804.pdf, 2009;
MALKIN, Why No One has Solved Event Discovery, http://www.hughmalkin.com/blogwriter/2015/9/23/why-no-one-has-solved-event-discovery (2011); and
ZHENG et al. GeoLife2.0: A Location-Based Social Networking Service, http s://www.researchgate.net/profile/Yukun_Chen2/publication/221422557_GeoLife20_A_LocationBased_Social_Networking_Service/links/0046352f4ab676a298000000/GeoL ife20-A-LocationBased-Social-Networking-Service.pdf (2009).

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 is a flow diagram of a personalization process;

FIGS. 2A-E are flow diagrams illustrating a process of loading and curating content;

FIG. 3 is a flow diagram illustrating content delivery to a user;

FIG. 4 illustrates a graphical user interface of an exemplar user feed;

FIGS. 5A-F illustrate a series of graphical user interfaces that support a content creator finding and engaging a business and managing agreements;

FIG. 6 is a flow diagram illustrating target business identification;

FIGS. 7A-F illustrate a series of graphical user interfaces that support a business finding and engaging a content creator and managing agreements;

FIG. 8 is a flow diagram illustrating target content creator identification; and

FIG. 9 is a flow diagram for managing an agreement process.

### DETAILED DESCRIPTION

The disclosed systems and methods solve a variety of problems. In one aspect, the systems and methods solve the problem discovering local happenings, particularly in a timely and relevant way, and finding things to do in a local area. These solutions are especially useful when a user does not know where they want to go or what they want to do. Users of the system can be consuming users (e.g., users that use the system for a local discovery of things to do and places to eat), content creator users (e.g., users that create content about local activities and places to eat), and business users (e.g., users that have a local place to eat or participate in an activity). In some instances, a user can fit more than one user category (e.g., a content creator user can also be a user that is a consuming user).

There are a number of factors that make these problems difficult to solve, including: (1) the challenge of accessing large volumes of information for a variety of local events; (2) local information is often disorganized and confusing; (3) processing information about events is time consuming; (4) currently available content makes it is difficult for a user to get a sense of what kind of experience to expect; and (5) consumer behavior dictates that event consumption happens in waves. Thus it can be difficult to match the timing of events, for example, with an individual consumer's mood or interest. Moreover, as will be appreciated by those skilled in the art, events typically have a short shelf life and diminish in value the greater the geographic distance from a user. So while an internet search of “things to do in San Francisco” will yield a variety of lists, whether or not any of the locations are currently open or the activities are currently available requires additional effort and research. Moreover, the list will not include events that may have a pop-up or transient nature.

The disclosed systems and methods provide several advantages. In one aspect of the systems and method, a mechanism is provided to generate large volumes of visual content spanning a wide spectrum of local news through a crowdsourcing mechanism. The crowdsource mechanism provides greater coverage for a user of what is happening in a local geography or community in the manner of timeliness and relevancy.

Additionally, the systems and methods provide quick and easy access and navigation through delivered content. The quick and easy access enhances the user experience around the exploration and discoverability of local events through visual content that is organized by geo-location, categories, and time information. Moreover, the user can set a geo-location range or a default geo-location range (e.g., device GPS location) can be used. For example, events within 5 square miles of the set geo-location or default geo-location, 10 square miles, 25 square miles, etc. Additionally, information can be presented based on proximity to the user based on a current location or an intended location. In some configurations, geo-location range can be set dynamically based on, for example, content density. Dynamic information can be based on an amount of content generated within a defined area, such as 1 square mile. For example, in places like San Francisco CA and New York City NY, the content density could be a lot higher and so the geo-location range might be smaller than Phoenix Arizona. Additionally, as more content is added, the geo-location can also dynamically change to present the closest and most recent content first, and then present additional content in widening geographic or time based circles.

The systems and methods further are configurable to use visual content to increase the ability of a user to process larger volumes of information. As will be appreciated by those skilled in the art, visual content can better and more quickly portray or communicate to a user an event experience—particularly when compared to a text description or review. Use of visual content will increase the likelihood of matching a local event with a user's interest at that particular moment.

Systems can comprise: an interface configured to: receive first location information of a first location for a first user, and receive a second location information for each one of a one or more second users; receive a first user location range preference from the first user; receive one or more first user category selections from the first user; and receive one or more second user category selections from each of the at least one or more second users; one or more processors communicatively coupled to the interface and configured to: determine if the second location information for the one or more second users is within a first user location range; determine if at least one of the one or more first user category selections from first user and the one or more second user category selections from each of the at least one or more second users is the same; and in response to determining that a location type is within the first user location range and at least one of the one or more category selections for the one or more second users is the same as at least one of the first user, cause information to be presented to the first user, the information to be presented to the first user comprising a list of second users within the first user location range and a first user category from the is the same as at least one second user category. Additionally, the system can determine if the second location information for each of the one or more second users is within the first user location range. To determine a preference related to a second user regarding a location type can further comprise receive a submission of a preferred location type of the second user. The one or more processors can further be configured to compare the first location information to a database and correlate location information with location types. Additionally, the information to be presented to the first user further comprises presenting additional information for at least one of the one or more second users. Additionally, the processors can receive one or more connection requests from the first user, communicate one or more offers from the first user to at least one of the one or more second users, and/or store an agreement between the first user and at least one of the one or more second users. The systems can be provided on non-transitory computer-readable medium encoded with logic configured to execute the system instructions. Additional methods can be performed according to the system instructions.

Systems, non-transitory computer readable medium encoded with logic and methods can also be provided that comprise: receiving first location information of a first location for a first user, and receive a second location information for each one of the one or more second users; receiving a first user location range preference from the first user; receiving one or more first user category selections from the first user; and receive one or more second user category selections from each of the at least one or more second users; determining if the one or more second location information for the one or more second users is within a first user location range; determining if at least one of the one or more first user category selections from first user and the one or more second user category selections from each of the at least one or more second users is the same; and in response to determining that a location type is within the first user location range and at least one of the one or more category selections for the one or more second users is the same as at least one of the first user, cause information to be presented to the first user, the information to be presented to the first user comprising a list of second users within the first user location range and a first user category from the is the same as at least one second user category.

Systems, non-transitory computer readable medium encoded with logic and methods can also be provided that comprise: receiving at the server computer a video, the video containing location information indicating a physical location of the video at a time the video is received or a time the video is created; receiving one or more categories for the video from a first user; the server computer parsing from the video the physical location of the video at the time the video was created and the one or more categories, determining from the video a target delivery location for the video based on the location information and the category; and delivering the video to a second user based on the location information and the category.

Systems, non-transitory computer readable medium encoded with logic and methods can also be provided that comprise: receiving at the server computer a video, the video containing location information indicating a physical location of the video at the time the video is received; receiving one or more categories for the video from a first user; the server computer parsing from the video the physical location of the video at the time the video was created and the one or more categories, determining from the video a target delivery location for the video based on the location information and the category; and delivering the video to a second user based on the location information and the category.

Turning to the disclosure in more detail, disclosed are at least I. social engagement discovery systems and methods, II. content creator tools, III. business tools, and IV. agreement management tools.

I. Social Engagement Discovery

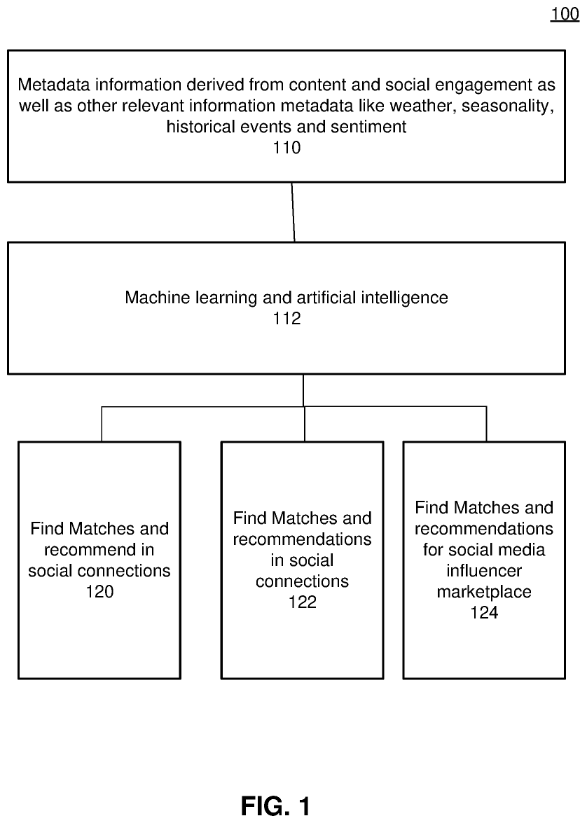

Turning now to FIG. 1, the systems and methods also provide a way to tailor/personalize user experiences and recommendations for social engagement through machine learning and artificial intelligence. Social engagement information includes, but is not limited to information about local businesses, local events, and local areas of interest. The large volumes of information derived from the content and social engagement, as well as other relevant information metadata, like weather, seasonality, historical events, and sentiment, serves as a rich source of data 110 in which deep learning and artificial intelligence 112 can be used to:
Enhance the ability to predict trends and intentions and increase the likelihood of matching user's interest with what's happening at the moment by way of personalized recommendations or curations 120;
Find matches and recommendations in social connections 122 between users and other types of entities, such as businesses, organizations, services, product, etc.;
The ability to find matches and recommendations for an influencer marketplace 124 between content creators and cliental; and
Recommend types of content to create. For instance, highlighting a hiking trail where a certain flower species is in bloom at a specific time of the year.

A system and methods for establishing a social capital system (gamification/token system/trust/reputation) which users can accrue and use within the platform and with other entities in the platform, like merchants.
New tokens can be created in an event when there's value being added to the platform, e.g.:
   New posts are added
   Comments
   Likes
   Shares
   New Collections/Boards
   Tagging?
   New Local Member & Merchants Sign Ups?
   Referrals?
   Purchases from merchants
Tokens can be used as a reward or as loyalty points through merchants, in which users can use the points with merchants to get free or discounted offering
This is could possibly be a form of digital currency for use within the platform ecosystem in transactional exchange of goods and services

The system has two primary types of users, content creators and content consumers. A third type of user is a business or organization. An individual user can be a content creator in one context and a content consumer in another context. A business or organization can create content or use a content creator to facilitate creating content.

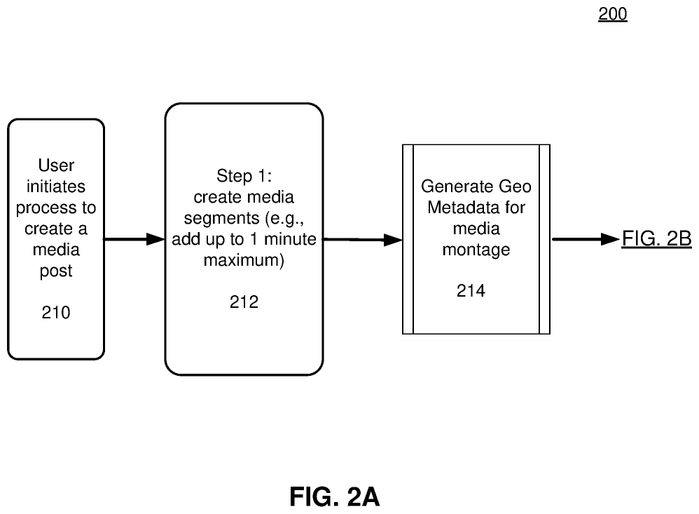

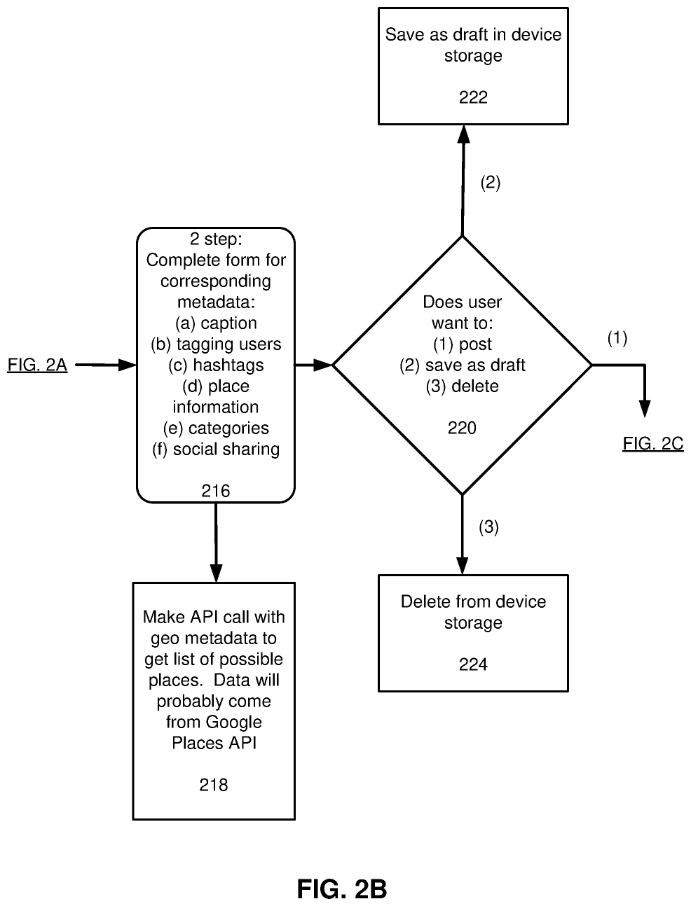

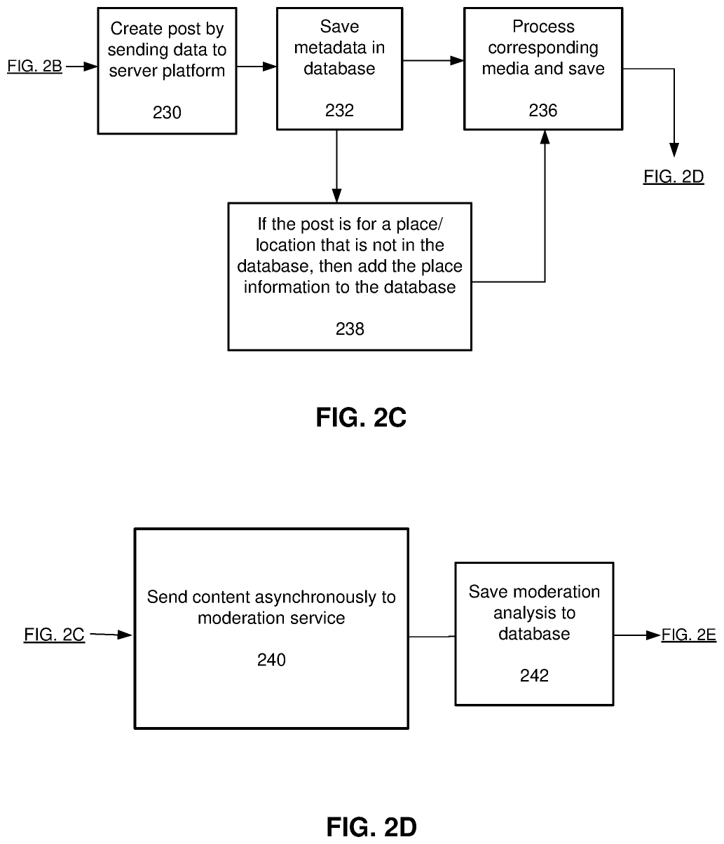

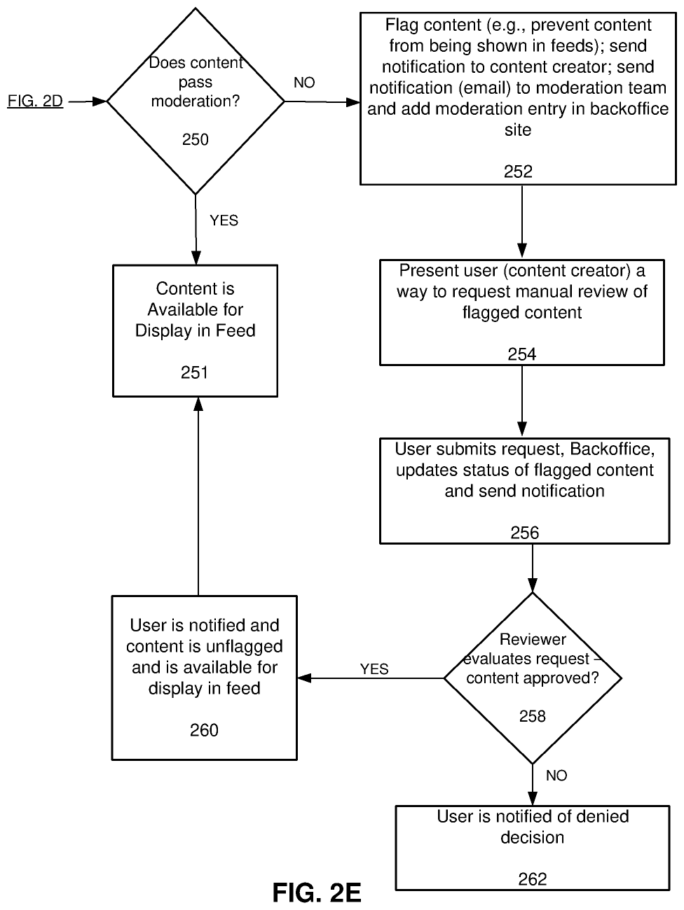

FIGS. 2A-E are flow diagrams illustrating a process of loading and curating content 200 by a user (content creator). Generated content results in the form of a post of content to a website. Creating content starts with a user initiating a process to create, for example, a video post 210 or a photographic post. The video can be created in segments that have a time length, such as 1 minute 212. Other time lengths can also be used. During the capture process, the system can use either GPS (e.g., location information) or IP address to gather current geolocation information 214, e.g. metadata for a video montage.

During the content creation process, systems and methods that uses machine learning and artificial intelligence to analyze recorded video content and provide recommendations. Additionally, the system can be configurable to automatically select and mix in audio tracks based on a variety of factors, such as venue type, local culture, seasonality, genre attributes, personality traits of the content creator.

Geolocation information can be used to associate with a place/venue. Information details for the venue can be provided by 3rd-party sources, like Foursquare and Google Places. Users can opt to select a different place/venue if the default option is not correct. From the place details, the systems and methods are configurable to derive a category for the post, e.g. restaurant or hiking. Users can also add other categories that are deemed appropriate, e.g. kids' activities. The user can complete a form with corresponding metadata, e.g., caption(s), user tagging, topical hashtags, location information, categories and social sharing 216. Afterwards an API call can be made 218 with the geo metadata to get a list of possible places. As will be appreciated by those skilled in the art, geo metadata can be sources from, for example, Google Places API.

Once the metadata is associated with the content, the user can select whether to post the content, save the content as a draft or delete the content 220. If the user elects to delete the content (3), then the content can be deleted from the device, such as phone, storage 224. If the user elects to save the content as a draft (2), then a draft is saved in the device storage 222 (FIG. 2C). If the user elects to post the content, a post is created and the data is sent to the server platform 230. Metadata from the post can be saved in a metadata database 232 and the video can be processed and saved 236. If the post is for a location that is not in the database, then the location is added to the database 238 prior to processing.

Once the video is processed and saved, the content is sent asynchronously to a moderation service 240 (FIG. 2D). The content moderation service can monitor submissions from the users and apply a set of rules which define acceptable and unacceptable content. The content moderation can then remove or reject unacceptable content. Moderation analysis for content can be saved to a database 242. The system determines if the content passes moderation 250. Content can be flagged during this process and a notification can be sent to the user (content creator) 252. The user (content creator) can request a manual review of flagged content in the event that the user believes the content was erroneously flagged 254. The status of the content is updated with the user (content creator) request for review 256. The content is evaluated 258 after which, if approved, the user is notified and content is unflagged and available for display in the feed 260, or, if the content is not approved, the user is notified of a continued denial of the content 262.

If the content does pass moderation 250, or is unflagged 260, then the content is available for display in the feed 251.

For users that are content consumers, content feeds are dynamically generatable based on two primary criteria: geolocation and category. Using the geolocation derived from the electronic device, content posts are queried based on proximity from the electronic device. Content density can be factored in dynamically based on geo-location boundaries for a querying post. Posts are grouped into category content feeds. The categories are presented in a user interface where a user can switch to see posts for the selected category.

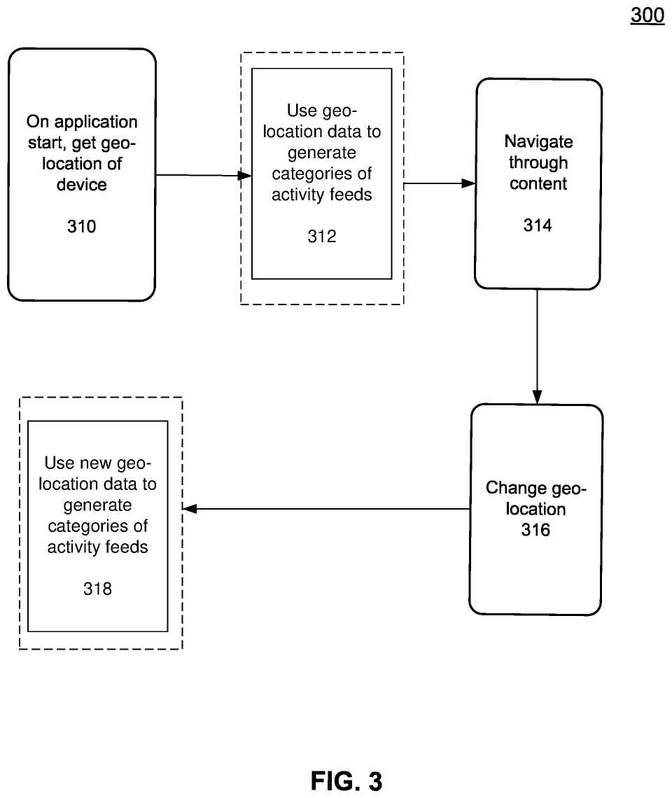

Turning to FIG. 3 when the application is started or launched 300, the geo-location for the electronic device is determined 310. Suitable electronic devices include, but or not limited to smart phone, tablets and computers. The geo-location data is used to generate categories of activity feed 312. Categories are generated dynamically in response to available activities. Thus if there are no activities in a category, the category will not be displayed. The user can then navigate through the content 314. Available content can be loaded or pre-loaded into a queue for presentation to a user immediately without delay. Alternatively, a user can select a location.

As noted above, geolocation information can be used to generate customized content for an individual user feed. The name of the community can be shown in the feed for the geo-location. User can change location 316 by opening a map view and moving, for example, a pin to another area on the map. Alternatively, the user can enter a zip code or a map coordinate. A new data set is then generated and presented 318 to the user.

The categories can be displayed in a horizontal list that users can swipe across to see the activity feed for the selected category.

The activity feed can have a list of video posts that are displayed in chronological order from recent to older, or in geographic order from closest to furthest, or a combination thereof. The activity feed can be presented in a calendar view and/or a map view.

The video posts can automatically play and/or start when the app opens, or when a user scrolls to the video. Videos can also automatically loop. Additionally users can select whether videos will loop individually or whether a range of content in a category will loop all available content.

Content overlay can be provided. The content overlay can show username of the content creator, the name of business or location, a timestamp (actual time or time elapsed from current time (e.g. “10 mins ago”), a special marker for things like “challenges,” and/or a text content for the two most recent social engagement (e.g. comment or like).

Sub-view and features can also be provided. For example, users can share a post. Sharing can occur between, for example, fans/followers within the application, via other applications (e.g., Instagram or Facebook) and/or via SMS or email. Posts can also be added to a save list. Users can also follow content creators to favorites list. Users can also follow location/business in a favorites list. The creators and businesses can be in the same favorites list, or separate favorites lists can be created, such as favorite content creators, favorite content creators for food, favorite businesses, favorite businesses for food. User can see and contribute to a messaging feed, i.e., the system and methods can provide for social engagement. Users can “thank” the post and see the number of “thanks,” for example. Post highlights can also be provided such as “2 Most thanked comments” and/or a list of historical posts.

Additionally, location and/or business details can be provided including, for example, logo or brand image, description of the location or business, phone number, address and map, operating hours and/or commercial offerings (e.g., menus, products sold, etc.).

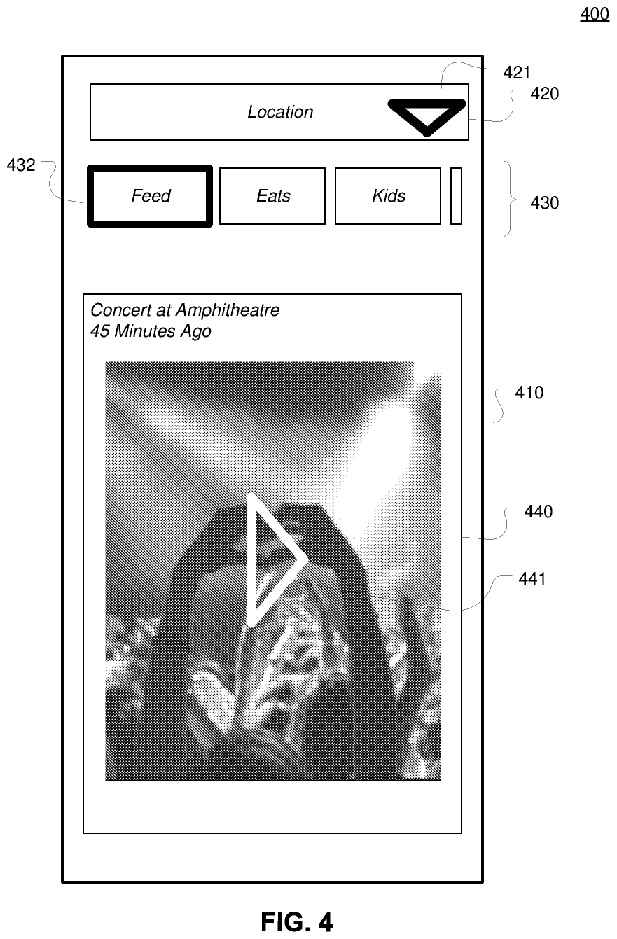

FIG. 4 illustrates a graphical user interface of an exemplar user feed 400 or on an electronic device 410. The user feed 400 identifies a location 420, such as Phoenix Arizona, and a topical ribbon 430. The location ribbon can allow the user to change location via, for example, a drop down feature 421. The topical ribbon 430 has a plurality of tabs that organize the available feeds by topic. For example, a first tab 432 could be a daily feed tab that presents all of the content available and organized by age of content, with the most recent content presented first. Other tabs, can be directed to other categories, or other categories of interest to the user based on a user profile. Tabs and categories can be changed at any time by a user. For example, parents might be interested in seeing food related items (“eats”), child friendly related items (“kids”) and outdoor activities. Whereas a young adult may want to see food related items, nightlife and outdoor activities. Based on the selected tab, highlighted as first tab 432 in FIG. 4, content 440 is presented. The content 440 presented defaults to a most recent content for that category. However, other presentations can be used without departing from the scope of the disclosure. For example, content could be presented based on distance from current location (using the device GPS information), or organized by posting entity (content creator or business). The content can automatically begin to start once the content is on the screen, or can be started and/or stopped by selecting an stop-go interface feature 441. To start, a user would, for example, press an icon of a triangle with the narrow portion pointing to the right. To stop, an icon of two parallel vertical bars could be used. Other functional icons including fast forward, reverse, and repeat can also be provided. User interface buttons can be provided that allow a user to comment on a video and/or like a video. Users can scroll right-left and/or up-down to change content.

II. Content Creator Tools

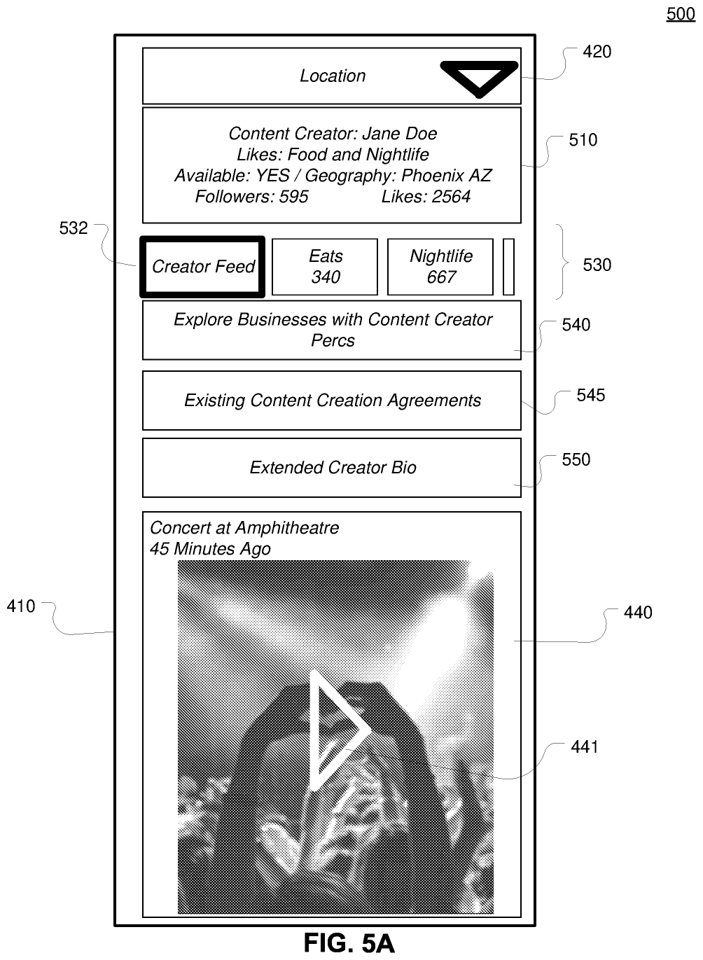

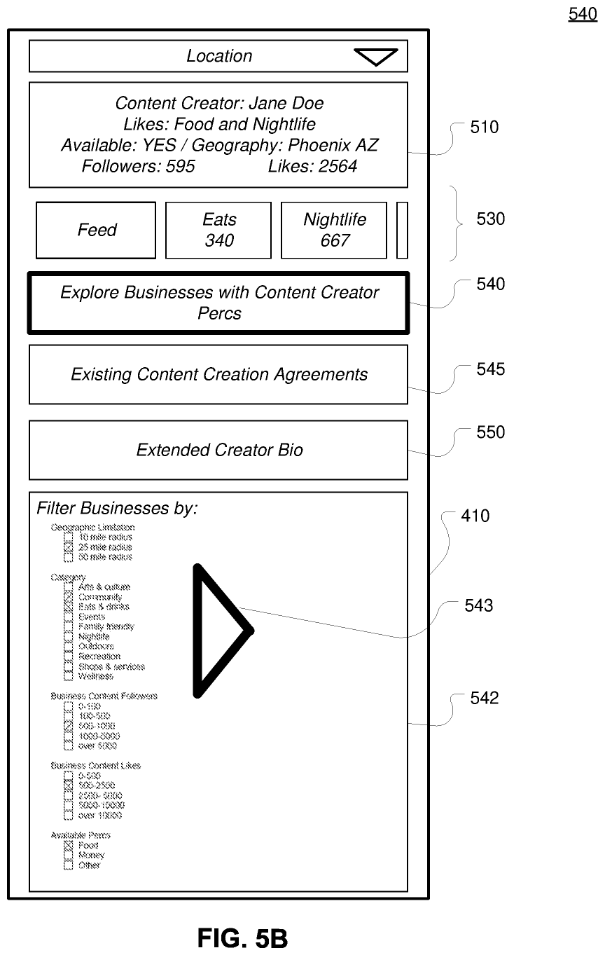

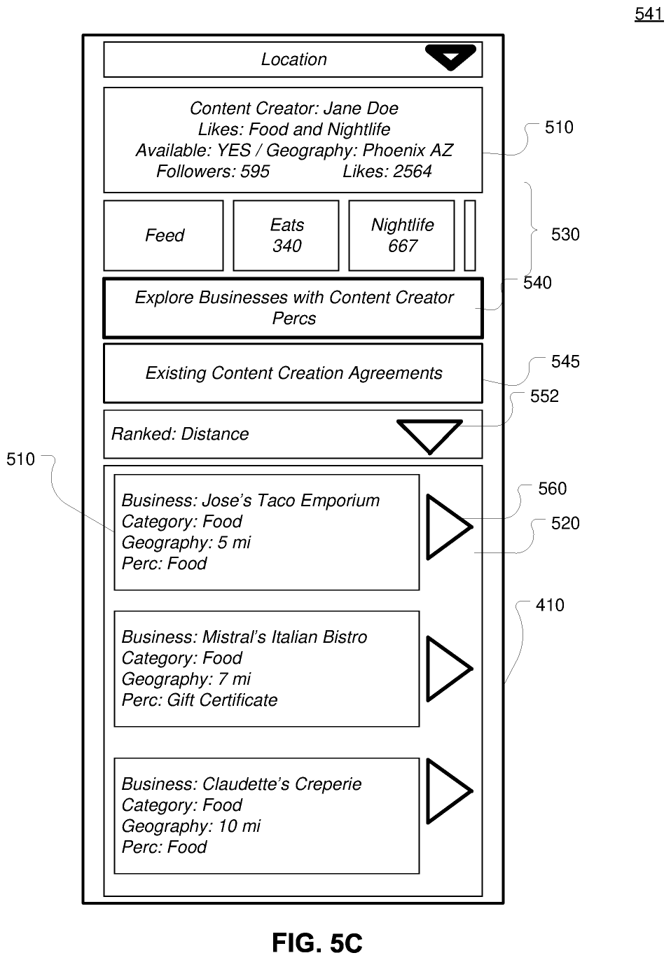

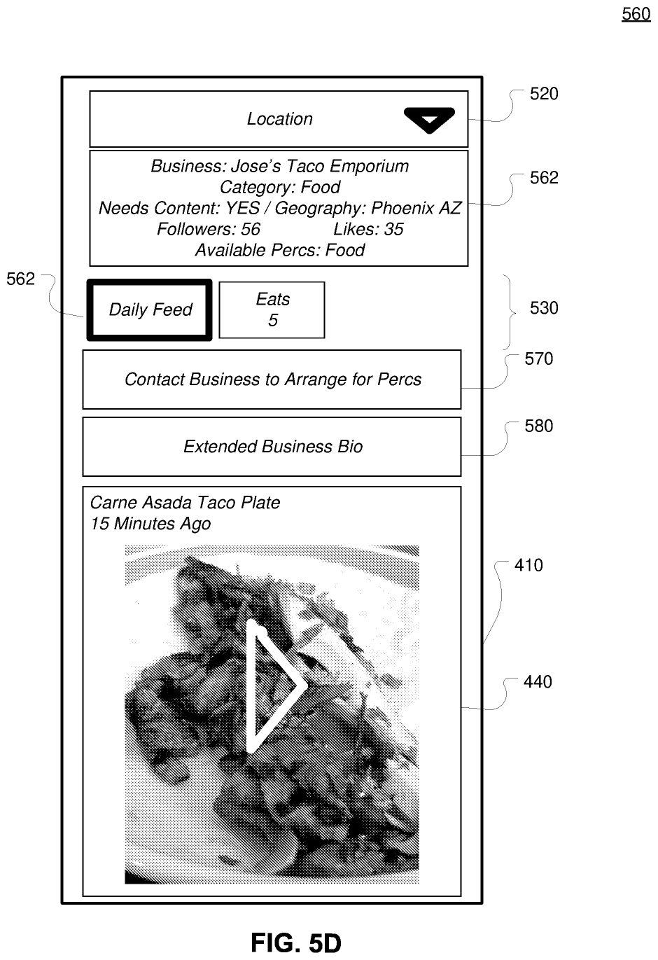

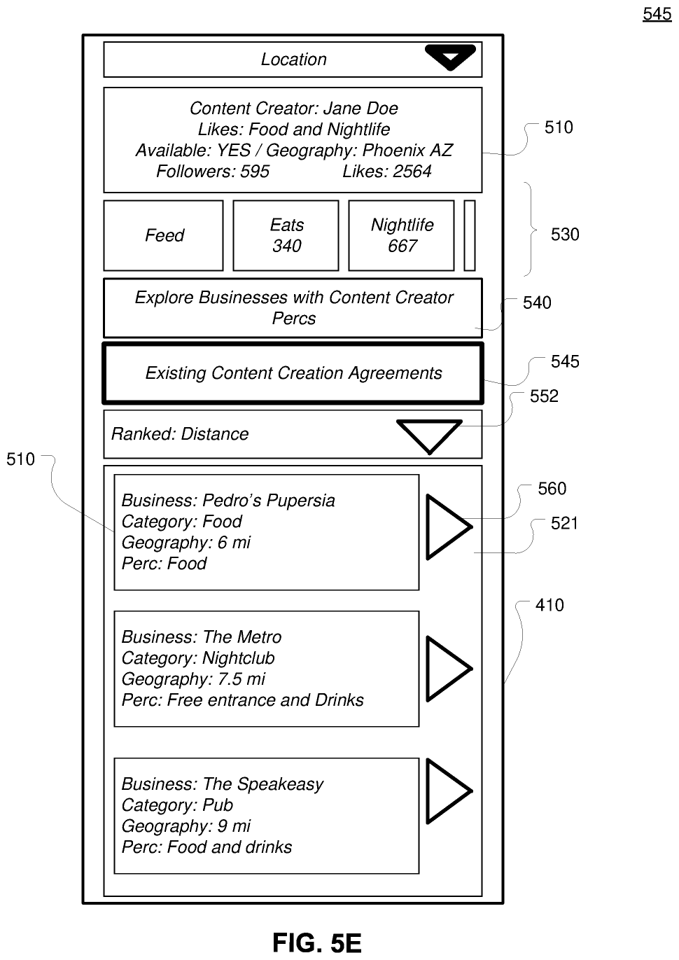

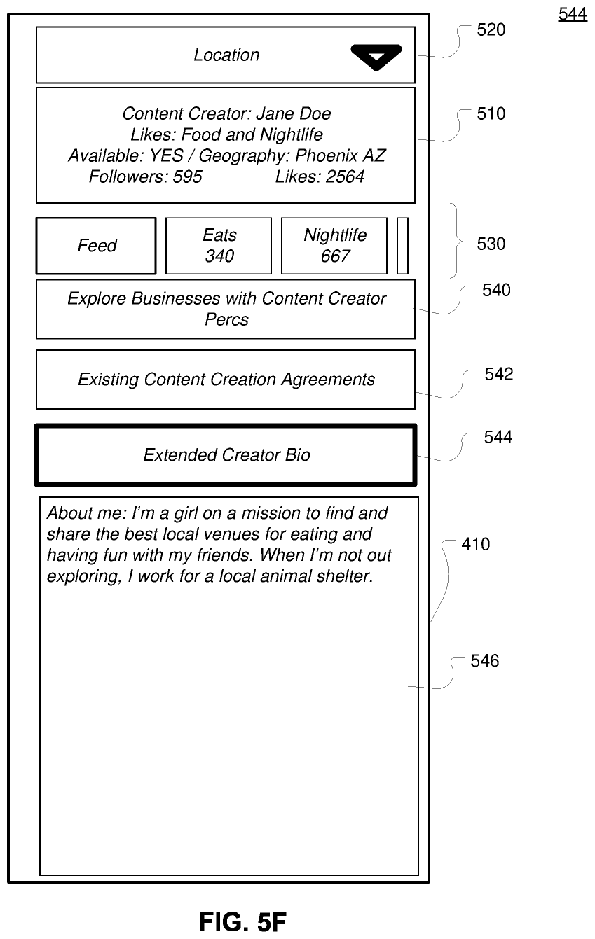

Turning now to FIGS. 5A-F a series of graphical user interfaces is provided that support a content creator user finding and engaging a business user and tracking their influence metrics. An initial content creator screen 500 can include, for example, the location 420 and a snapshot of the user 510. In a content creator view, the content creator ribbon 530 can provide a first tab 532 for a feed of all the content prepared by the content creator, and a content 440 presented in a manner similar to FIG. 4. Additional tabs or filters can be provided that allow the content creator to see content that has been drafted and content that has been published. Additional tabs can be provided for the categories of content that has been published which indicates the number of content items posted, e.g., “eats 340.” Additionally, the ribbon can include tabs for content exploration as described in FIG. 4.

A tab for exploring businesses with content creator perquisites 540 (“perks”) is also provided. To explore businesses with perks 540, the content creator would select the explore tab 540 and be taken to a new interface (FIG. 5B) which provides the option of filtering businesses 540. A series of business filtering categories 542, such as geographic limitation, content category, number of content followers, number of business content likes, and available perks can be provided. Once the categories are customized, the user can press a go icon 543 to proceed to a business summary view 541 (FIG. 5C). For example, a content creator may not want to create content beyond a 25 mile radius, may only want to focus content on community events and eats & drinks to foster becoming recognized as a person “in the know” in a particular geographic area and/or for a specific category. Additionally, filtering can include number of followers a business has, number of business content likes, available perks, and/or number of content creators. Thus, for example, a business with a smaller number of followers and likes may be more interested in using a content creator to drive business to their business. A business with a large following and a large number of likes might be less inclined to provide perks for content creation. Once the user opts to proceed with the filter, a list of businesses will be provided 520 with information about the business such as name, distance from current location, type of perk offered, etc., as shown in FIG. 5C. The businesses can further be ranked, e.g. by distance. Ranking can be changed by interacting with a drop down 552.

Selecting a business 560 will take the content creator to a new interface for a business summary 560, such as FIG. 5D. From the business page, the content creator can get a better understanding of the business metrics including categories, content posts, likes, followers, etc. The user can contact the business 570 from the interface and/or review an extended business bio 580. A business feed 562 is provided in the ribbon 530. The content can be organized by an entire business feed, as well as one or more additional tabs for content organized by category.

FIG. 5E shows a list of businesses that the content creator has an existing agreement with and a summary of the perks. FIG. 5F is an extended bio page which provides potential businesses additional information about the content creator.

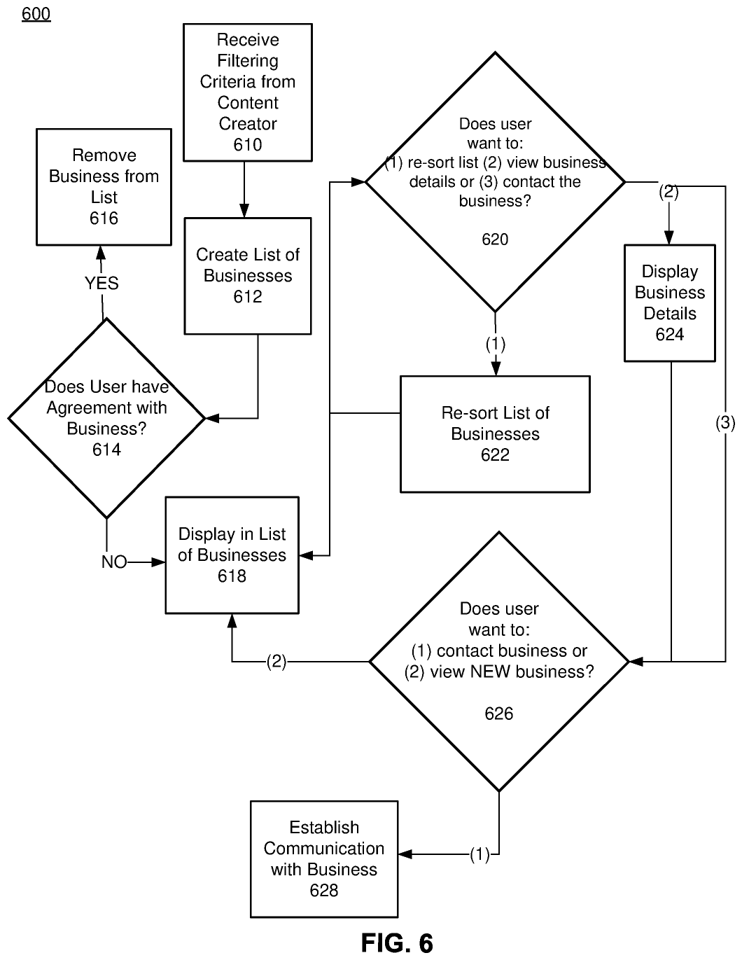

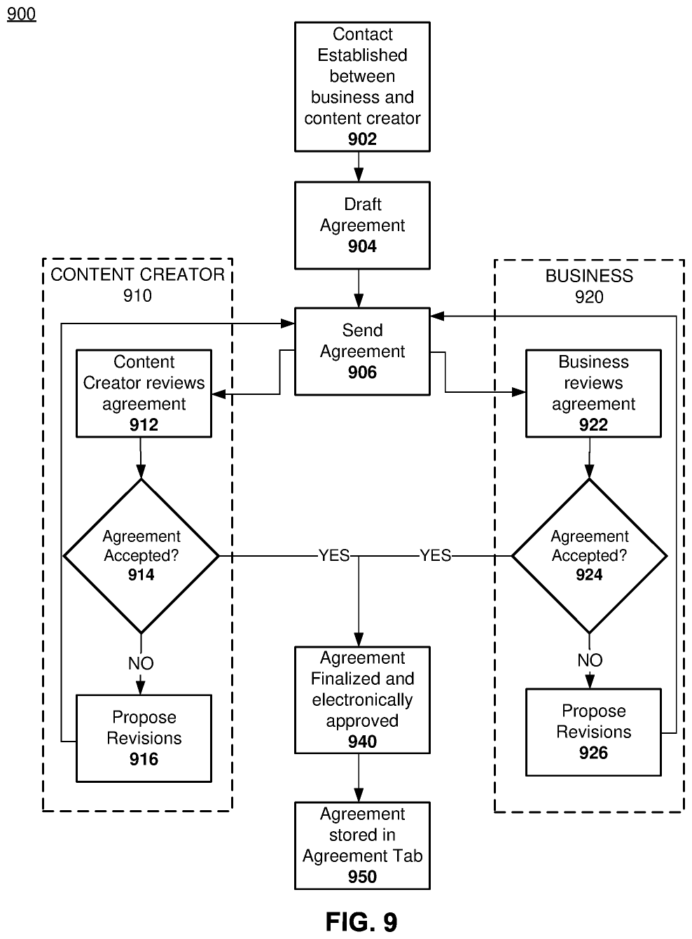

FIG. 6 is a flow diagram illustrating target business identification 600. After starting the process, the user provides filtering criteria for businesses of interest 610. Once the filtering criteria is received, a list of businesses is created 612. The list of businesses is analyzed to determine if the user has an existing agreement with the business 614. If the user does have an existing agreement (YES), then the business is removed from the list 616. Once the list of businesses is created it is displayed 618 on the user interface. Once the list is displayed, the user can (1) re-sort the list, (2) view business details or (3) contact the business 620. If the user chooses to re-sort the business, then the list of businesses is re-sorted 622 and displayed 618. If the user wishes to see further information about a business, the user can choose to view the business details at which point business details are displayed 624. The user can then decide if it wants to (1) contact the business or (2) view a new business 626. If the user wants to contact the business (1), then communication is established with the business 628. If the user wants to view a new business (2), then the user can return to a display of the list of businesses 618. Additionally, the user can proceed from the list of businesses or a re-sorted list of businesses directly to contacting the business without needing to see business details. The user can also exit the process at any time. Once contact is established with the business, an electronic agreement can be entered into (FIG. 9), the existence of the electronic agreement can be maintained in the existing content creation agreements page such as shown in FIG. 5E.

III. Business Tools

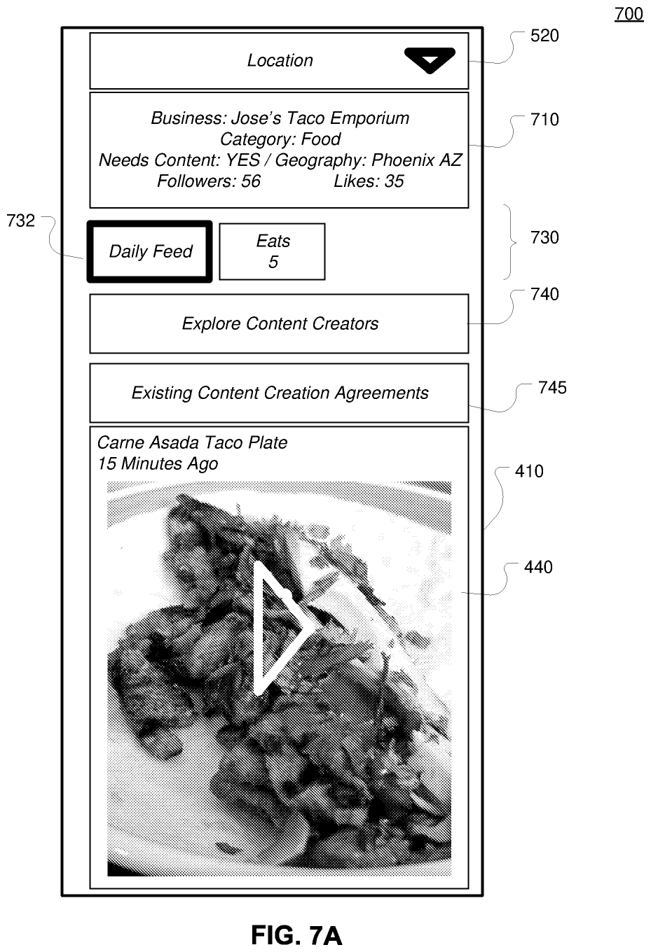

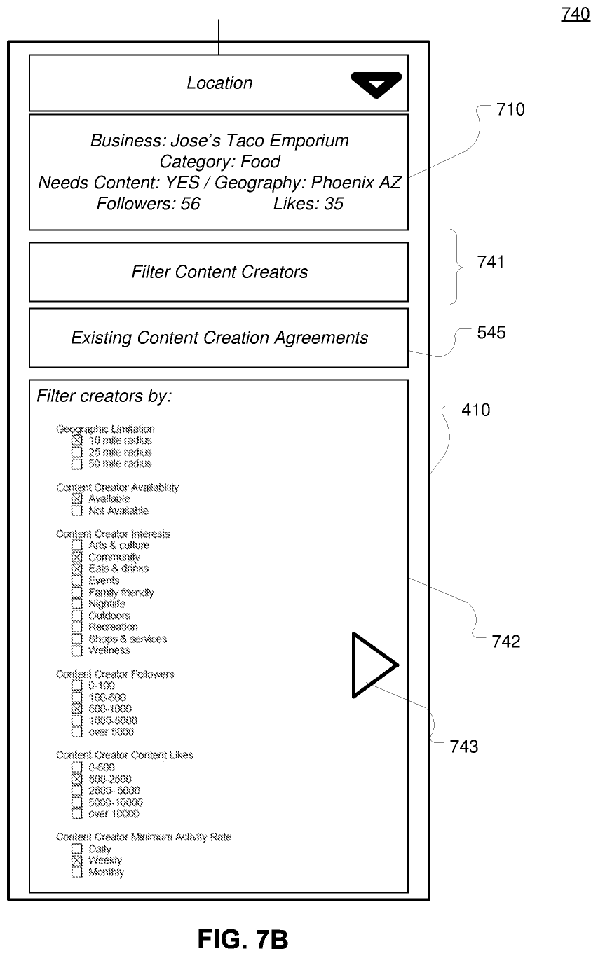

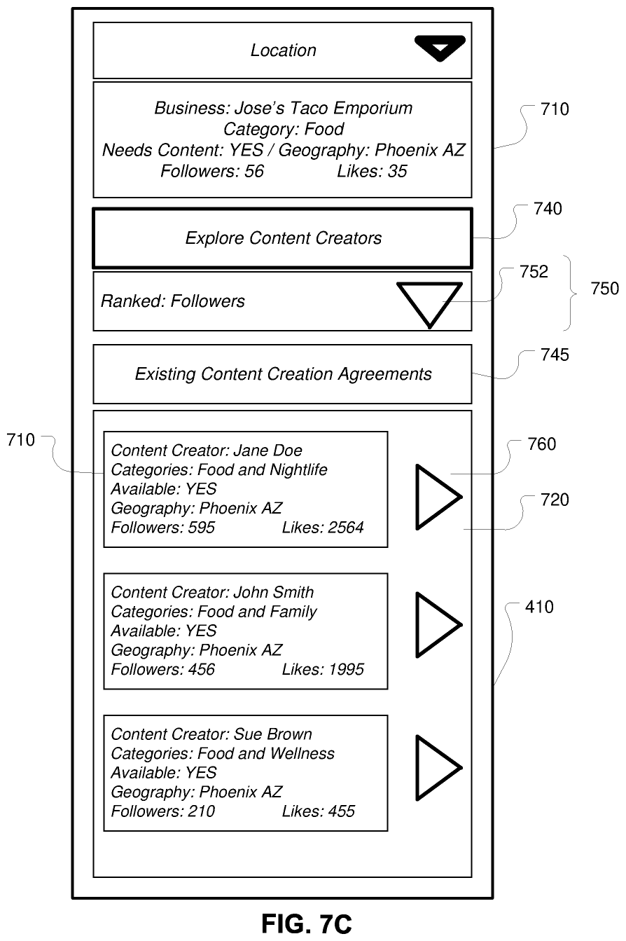

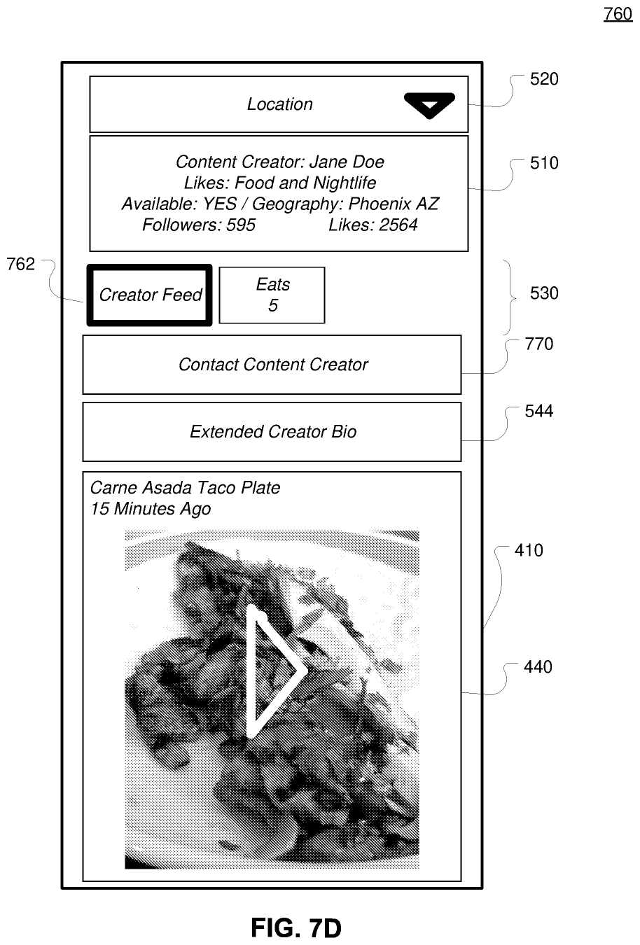

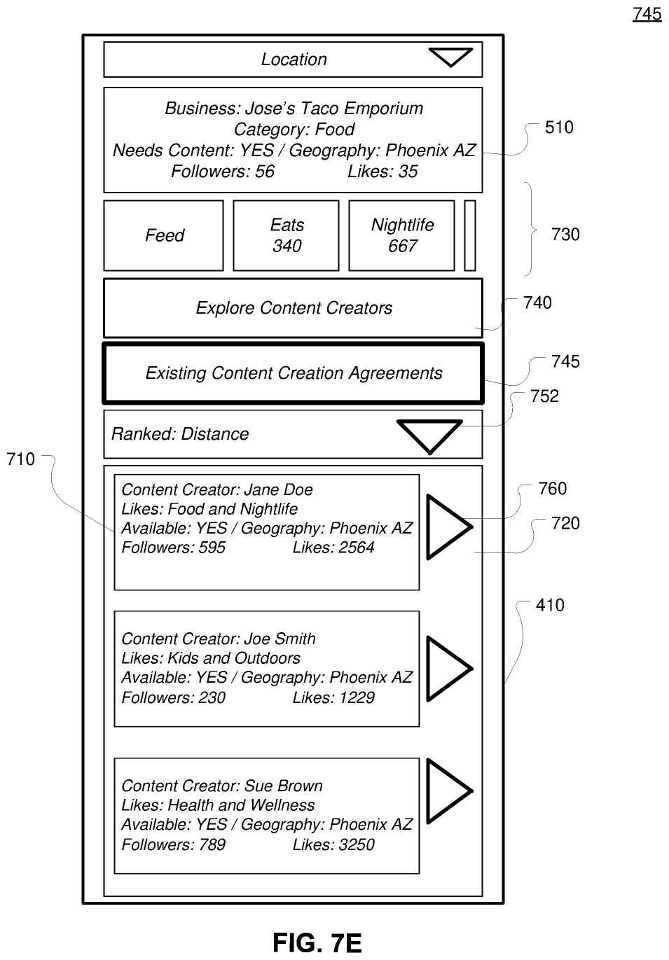

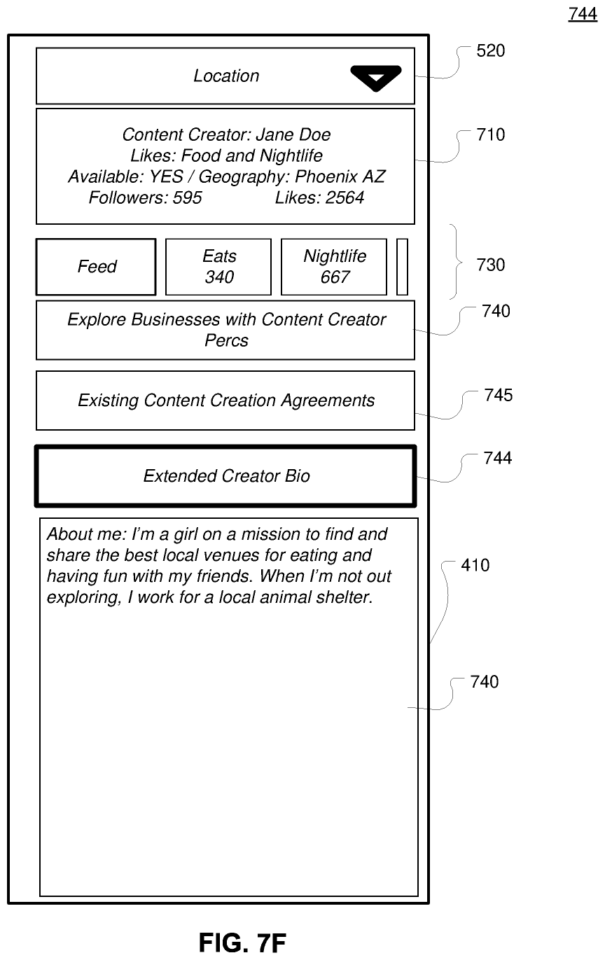

Turning now to FIGS. 7A-F, a series of graphical user interfaces is illustrated that support a business finding and engaging a content creator. An initial content creator screen 700 can include, for example, the location 720 and a snapshot of the business 710. In a business view, the business ribbon 730 can provide a first tab 732 for a feed of all the content prepared for the business by any user. A content 440 for the business is presented in a manner similar to FIG. 4. Additional tabs or filters can be provided that allow the business to see content that has been drafted and content that has been published. Additional tabs can be provided for the categories of content that has been published which indicates the number of content items posted, e.g., “eats 5.” A tab for exploring content creators 740 is also provided. To explore content creators 740, the business would select the explore tab 740 and be taken to a new screen, such as FIG. 7B which provides the option of filtering content creators 741. A series of content creator filtering categories 742, such as geographic limitation, availability, content creator interests, number of content followers, number of content likes, and minimum availability expectation can be provided. Once the categories are customized, the user can press a go icon 743 to proceed with filtering. For example, a business may not want a content creator create content beyond a 50 mile radius, may only want a creator that focuses content on community events and eats & drinks to ensure that the content creator is likely to be considered a person “in the know” about food in a specific community. Once the business opts to proceed with the filter a list of businesses will be provided with information about the business such as name, distance from current location, etc., as shown in FIG. 7C.

The content creators can further be ranked, e.g. by number of followers. Selecting a content creator will take the business to a new interface, such as FIG. 7D. From the content creator page, the business can get a better understanding of the content creator metrics including categories, content posts, likes, followers, etc. The business can contact the content creator 770 from the interface and/or review an extended creator bio 580. A creator feed 762 is provided in the ribbon 730. The content can be organized by an entire creator feed 762, as well as one or more additional tabs for content organized by category.

FIG. 7E shows a list of content creators that the business has an existing agreement with and a summary of the perk the business is providing. FIG. 7F is an extended bio page which provides potential businesses additional information about the content creator.

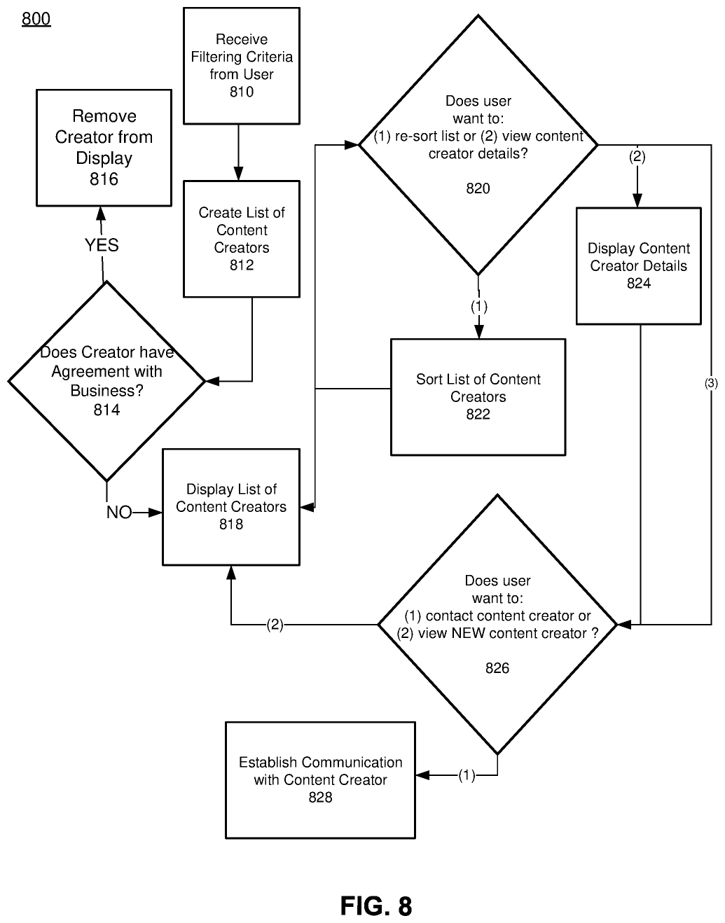

FIG. 8 is a flow diagram illustrating target content creator identification 800. After starting the process, the business provides filtering criteria for content creators of interest 810. Once the filtering criteria is received, a list of content creators is created 812. The list of content creators is analyzed to determine if the business has an existing agreement with the content creator 814. If the business does have an existing agreement (YES), then the content creator is removed from the list 816. Once the list of content creators is created the list is displayed 818 on the user interface. Once the list is displayed, the user can (1) re-sort the list, (2) view content creator details or (3) contact the content creator 820. If the user chooses to re-sort the content creators, then the list of content creators is re-sorted 822 and displayed 818. If the user wishes to see further information about a content creator, the user can choose to view the content creator details at which point content creator details are displayed 824. The user can then decide if it wants to (1) contact the content creator or (2) view a new content creator 826. If the user wants to contact the content creator (1), then communication is established with the content creator 828. If the user wants to view a new content creator (2), then the user can return to a display of the list of content creators 818. Additionally, the user can proceed from the list of content creators or a re-sorted list of content creators directly to contacting the content creator (3) without needing to see content creator details. The user can also exit the process at any time. Once contact is established with the content creator, an electronic agreement can be entered into, the existence of the electronic agreement can be maintained in the existing content creation agreements page such as shown in FIG. 7E.

IV. Agreement Management

FIG. 9 is a flow diagram for managing an agreement process 900 within the system. Contact is established between the business and the content creator 902. The request to establish contact can be initiated by either the business or the content creator as described above. Once contact is established, if the parties wish to proceed an agreement is drafted 904. The agreement can include preselected terms by the entity initiating contact and/or initiating the agreement. The draft agreement is then sent to the content creator 910 and the business 920. The content creator reviews the agreement 912 and has the option of accepting the agreement 914, YES or NO. If the agreement is accepted (YES), then the agreement proceeds to be finalized and electronically approved 940. If the agreement is not accepted (NO) then the content creator can propose revisions 916, at which point the revised agreement is sent 906 to the business 920 for the approval process.

The business 920 also reviews the agreement 922 and has the option of accepting or rejecting the agreement 924, YES or NO. If the agreement is accepted (YES), then the agreement proceeds to be finalized and electronically approved 940. If the agreement is not accepted (NO) then the business can propose revisions 926, at which point the revised agreement is sent 906 to the content creator 910 for the approval process. In order to proceed with finalization 940 both the content creator 910 and the business 920 must accept the agreement 914, 924 (YES. Once the agreement is accepted by both parties, the agreement is stored in the agreement tab 950. Agreements can also be archived from the system if they are no longer active or are terminated by either party.

V. Additional Systems and Functionality

As will be appreciated by those skilled in the art, blockchain can be used for aspects of the systems and methods, such as the digital currency process without departing from the scope of the disclosure. A blockchain can be comprised of one or more blocks (digital information) and/or sub-blockchains which can also be comprised of one or more blocks, in a chain (database). Blocks store information about transactions. A single block on a blockchain can store as much as 1 MB of data (e.g., a few thousand transactions per block). Once a process is completed, the block can be configured so that it cannot be written to following completion. Data, e.g. event records, blocks and/or blockchains (such as sub-blockchains) can be appended to a blockchain. The blockchain is a distributed ledger system on a peer-to-peer network that operates without utilizing a centralized transaction authority. The blockchain distributed ledger provides transparency and immutability. Changes to the blockchain ledger are viewable by all permissioned participants and the corresponding transactions cannot be altered or deleted. Additionally, the system is configurable to generate a unique hash value for each of the block entries, such as documents reviewed and signed, based on a secure hash algorithm in real time and store each unique hash value on the voucher blockchain.

In engaging the systems and methods according to aspects of the disclosed subject matter a user may engage in one or more use sessions. A use session may include a training session for the user.

Any of the disclosed methods can be implemented as computer-executable instructions stored on one or more computer-readable storage media (e.g., non-transitory computer-readable media, such as one or more optical media discs, volatile memory components (such as DRAM or SRAM), or nonvolatile memory components (such as flash memory or hard drives)) and executed on a computer (e.g., any device capable of a computing function that includes computing hardware). As will be appreciated by those skilled in the art, computer-readable storage media does not include communication connections, such as modulated data signals. Any of the computer-executable instructions for implementing the disclosed techniques, as well as any data created and used during implementation of the disclosed embodiments, can be stored on one or more computer-readable media (e.g., non-transitory computer-readable media, which excludes propagated signals). Additionally, the computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

Only selected aspects of the software-based implementations are described. Other details that are well known in the art are omitted. For example, it should be understood that the disclosed technology is not limited to any specific computer language or program. Likewise, the disclosed technology is not limited to any particular computer or type of hardware. Certain details of suitable computers and hardware are well known and need not be set forth in detail in this disclosure.

It should also be well understood that any functionality described herein can be performed, at least in part, by one or more hardware logic components, instead of software. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the internet, the world wide web, an intranet, software applications, cable (including fiber optic cable), magnetic communications, electromagnetic communications (including RF, microwave, and infrared communications), electronic communications, or other such communication means.

The disclosed methods, apparatus, and systems should not be construed as limiting in any way. Instead, the present disclosure is directed toward all novel and nonobvious features and aspects of the various disclosed embodiments, alone and in various combinations and sub-combinations with one another. The disclosed methods, apparatus, and systems are not limited to any specific aspect or feature or combination thereof, nor do the disclosed embodiments require that any one or more specific advantages be present or problems be solved.

The instructions may be stored on a suitable “machine readable medium” within a computing device or in communication with or otherwise accessible to the computing device. As used in the present application a machine readable medium is a tangible storage device and the instructions are stored in a non-transitory way. At the same time, during operation, the instructions may at times be transitory, e.g., in transit from a remote storage device to a computing device over a communication link. However, when the machine readable medium is tangible and non-transitory, the instructions will be stored, for at least some period of time, in a memory storage device, such as a random access memory (RAM), read only memory (ROM), a magnetic or optical disc storage device, or the like, arrays and/or combinations of which may form a local cache memory, e.g., residing on a processor integrated circuit, a local main memory, e.g., housed within an enclosure for a processor of a computing device, a local electronic or disc hard drive, a remote storage location connected to a local server or a remote server access over a network, or the like. When so stored, the software will constitute a “machine readable medium,” that is both tangible and stores the instructions in a non-transitory form. At a minimum, therefore, the machine readable medium storing instructions for execution on an associated computing device will be “tangible” and “non-transitory” at the time of execution of instructions by a processor of a computing device and when the instructions are being stored for subsequent access by a computing device.

As will be appreciated by those skilled in the art, the systems and methods disclosed are configurable to send a variety of messages when alerts are generated. Messages include, for example, SMS and email.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the claims define the scope of the invention and that methods and structures within the scope of these claims and their equivalents be covered thereby.

1. A system, comprising:
an interface configured to:
receive first location information of a first location for a first user, and receive a second location information for each one of a one or more second users;
receive a first user location range preference from the first user;
receive one or more first user category selections from the first user; and receive one or more second user category selections from each of the at least one or more second users;
one or more processors communicatively coupled to the interface and configured to:
determine if the second location information for the one or more second users is within a first user location range;
determine if at least one of the one or more first user category selections from first user and the one or more second user category selections from each of the at least one or more second users is the same; and
in response to determining that a location type is within the first user location range and at least one of the one or more category selections for the one or more second users is the same as at least one of the first user, cause information to be presented to the first user, the information to be presented to the first user comprising a list of second users within the first user location range and a first user category from the is the same as at least one second user category.

2. The system of claim 1, further comprising determine if the second location information for each of the one or more second users is within the first user location range.

3. The system of claim 1, wherein determining a preference related to a second user regarding a location type comprises receiving a submission of a preferred location type of the second user.

4. The system of claim 1, wherein the one or more processors are further configured to compare the first location information to a database and correlate location information with location types.

5. The system of claim 1, wherein the information to be presented to the first user further comprises presenting additional information for at least one of the one or more second users.

6. The system of claim 1 wherein the one or more processors are further configured to receive one or more connection requests from the first user.

7. The system of claim 1 wherein the one or more processors are further configured to communicate one or more offers from the first user to at least one of the one or more second users.

8. The system of claim 1 wherein the one or more processors are further configured to store an agreement between the first user and at least one of the one or more second users.

9. A non-transitory computer-readable medium encoded with logic, the logic configured when executed to:
receive first location information of a first location for a first user, and receive a second location information for each one of the one or more second users;
receive a first user location range preference from the first user;
receive one or more first user category selections from the first user; and receive one or more second user category selections from each of the at least one or more second users;
one or more processors communicatively coupled to the interface and configured to:
determine if the one or more second location information for the one or more second users is within a first user location range;
determine if at least one of the one or more first user category selections from first user and the one or more second user category selections from each of the at least one or more second users is the same; and
in response to determining that a location type is within the first user location range and at least one of the one or more category selections for the one or more second users is the same as at least one of the first user, cause information to be presented to the first user, the information to be presented to the first user comprising a list of second users within the first user location range and a first user category from the is the same as at least one second user category.

10. The computer-readable medium of claim 9, further comprising determine if the second location information for each of the one or more second users is within the first user location range.

11. The computer-readable medium of claim 9, wherein determining a preference related to a second user regarding the location type comprises receiving a submission of a preferred location type of the second user.

12. The computer-readable medium of claim 9, wherein the one or more processors are further configured to compare the first location information to a database, the database correlating location information with location types.

13. The computer-readable medium of claim 9, wherein the information to be presented to the first user further comprises presenting additional information for at least one of the one or more second users.

14. The computer-readable medium of claim 9, wherein the one or more processors are further configured to receive one or more connection requests from the first user.

15. The computer-readable medium of claim 9, wherein the one or more processors are further configured to communicate one or more offers from the first user to at least one of the one or more second users.

16. The computer-readable medium of claim 9, wherein the one or more processors are further configured to store an agreement between the first user and at least one of the one or more second users.

17-23. (canceled)

24. A computer-implemented method for presenting geographically tailored information stored in a database accessible by a server computer, the method comprising:
receiving at the server computer a video, the video containing location information indicating a physical location of the video at a time the video is received or a time the video is created;
receiving one or more categories for the video from a first user;
the server computer parsing from the video the physical location of the video at the time the video was created and the one or more categories, determining from the video a target delivery location for the video based on the location information and the category; and
delivering the video to a second user based on the location information and the category.

25. The method according to claim 24, wherein the video is received from a GPS-enabled mobile device.

26. The method according to claim 24, wherein the physical location has a name and the first user manually enters one or more categories.

27. The method according to claim 24, further comprising posting the video on the server for access by one or more second users.

28. (canceled)
